(19) United States
(12) Patent Application Publication
(10) Pub. No.: US 2025/0229661 A1
(43) Pub. Date: Jul. 17, 2025

(54) Automotive Solar Wrap Device

(71) Applicant: Derek Borel, Orange, TX (US)

(72) Inventor: Derek Borel, Orange, TX (US)

(21) Appl. No.: 18/958,203

(22) Filed: Nov. 25, 2024

Related U.S. Application Data
(60) Provisional application No. 63/621,004, filed on Jan. 15, 2024.

(51) Int. Cl. B60L 53/51; B60R 13/04; H02J 7/35; H02S 20/30

(52) U.S. Cl. CPC B60L 53/51; B60R 13/04; H02J 7/35; H02S 20/30

(57) ABSTRACT

A vehicle solar wrap device is disclosed, wherein the solar film converts solar power into energy to charge vehicles containing batteries. The vehicle solar wrap device comprises a body component that is configured in a shape of a vehicle. The body component is a thin wrap that functions like a protective automotive film. The film is applied to all painted surfaces of the vehicle. The body component captures solar energy through thin, flat photovoltaic cells to charge the vehicle's batteries. The film is laser measured and cut according to a vehicle's specific body panel, shape, and design. Further, the back sheet of the body component will contain an adhesive layer for application to the vehicle.

### CROSS-REFERENCE TO RELATED APPLICATION

The present application claims priority to, and the benefit of, U.S. Provisional Application No. 63/621,004, which was filed on Jan. 15, 2024, and is incorporated herein by reference in its entirety.

### FIELD OF THE INVENTION

The present invention relates generally to the field of vehicle solar wrap devices. More specifically, the present invention relates to a vehicle wrap or film designed to fit snugly on a vehicle exterior and absorb solar energy for converting it to usable power. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in vehicle solar wrap devices. Generally, electric vehicles are becoming increasingly more popular, however, finding charging stations while on the road can be difficult. Electric vehicle owners may be limited in how far they can travel due to battery constraints. Constantly stopping to charge vehicle batteries can be frustrating.

Further, the use of electric vehicles has increased rapidly, but the charging problem of electric vehicles is still in great trouble. Typically, the number of charging stations is small, and the waiting time is long. The charging of electric vehicles is relatively troublesome, and many charging problems have not been completely solved. Further, in particular, many families have not installed charging piles in the garage parking spaces. Accordingly, the charging current is large, the load is large, and the number of charging stations in some places is less. Thus, it is often necessary to plug and charge electric vehicles at undesirable times and locations, which can be relatively troublesome to do.

Additionally, battery powered cars are requiring less and less energy per mile and solar technology, specifically solar film, is increasing in their power conversion efficiency and cost in dollars per watt. Thus, tapping green renewable energy as a power source that is free energy after the initial fixed cost of the vehicle solar wrap device installation, can reduce or eliminate the need for paid charging depending on driving habits.

Accordingly, there is a demand for an improved vehicle solar wrap device that provides a vehicle wrap that absorbs solar energy for converting it to usable power. More particularly, there is a demand for a vehicle solar wrap device that utilizes a thin wrap that functions as a protective film applied to all painted surfaces on the vehicle.

Therefore, there exists a long felt need in the art for a vehicle solar wrap device that provides users with a vehicle wrap or film designed to fit snugly on a vehicle exterior and absorbs solar energy for converting it to usable power. There is also a long felt need in the art for a vehicle solar wrap device that allows users to travel or park their vehicle and charge their vehicle without plugging it into a power system. Further, there is a long felt need in the art for a vehicle solar wrap device that utilizes a thin wrap that functions like protective film and can be applied to all painted surfaces on the vehicle. Moreover, there is a long felt need in the art for a device that maximizes the available surface area for capturing solar energy while improving or maintaining vehicle aesthetics. Further, there is a long felt need in the art for a vehicle solar wrap device that offers a way to provide continuous power to an electric vehicle regardless of sun position. Finally, there is a long felt need in the art for a vehicle solar wrap device that can be available in numerous colors, styles and designs.

The subject matter disclosed and claimed herein, in one embodiment thereof, comprises a vehicle solar wrap device. The device is a solar film for converting solar power into energy to charge vehicles containing batteries. The vehicle solar wrap device comprises a body component that is configured into a shape to fit the body contour of a vehicle. The body component is a thin wrap that functions like a protective automotive film. The film is applied to all painted or selected surfaces of the vehicle. Thus, the film can be applied to all exterior surfaces reachable by sunlight. The body component captures solar energy through thin, flat photovoltaic cells (or other means, such as in the absorption of electromagnetic energy or gamma rays from solar radiation) to charge the vehicle's batteries. The film is laser measured and cut according to a vehicle's specific body panel, shape, and design. In one embodiment, the terminating ends of the bus bars will be attached to wires or the body of the vehicle itself, which will serve as the interconnection between the charge controller and the battery (or other power storage device). Further, the back sheet of the body component will contain an adhesive layer for application to the vehicle, such as a protective automotive film and window tint. In another embodiment, the body component can be prepared without an adhesive layer which can be added later or the body component can be applied via some other securing means. The device can be available in numerous colors, styles, and designs to accommodate all vehicles and all user needs and preferences.

In this manner, the vehicle solar wrap device of the present invention accomplishes all of the forgoing objectives and provides users with a device that fits on a vehicle's exterior and absorbs solar energy. The device accommodates all vehicle shapes and is available in numerous colors and designs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle solar wrap device. The vehicle solar wrap device comprises a body component that is configured in a shape of a vehicle. The body component is applied to all painted surfaces or selected surfaces of the vehicle. Thus, the film can be applied to all exterior surfaces reachable by sunlight. The body component captures solar energy through thin, flat photovoltaic cells to charge the vehicle's batteries. The film can be laser measured and cut according to a vehicle's specific body panel, shape, and design. Further, the back sheet of the body component will contain an adhesive layer for application to the vehicle.

In one embodiment, the vehicle solar wrap device provides users with a vehicle wrap or film designed to fit snugly on a vehicle exterior and absorbs solar energy for converting it to useable power. Thus, the device converts solar power into energy to charge vehicles containing batteries. The vehicle solar wrap device maximizes the available surface area for capturing solar energy while improving or maintaining vehicle aesthetics. Accordingly, the device offers a way to provide continuous power to an electric vehicle regardless of sun position.

In one embodiment, the vehicle solar wrap device can double as a protective wrap in some instances and can be produced to be ultra resistant to high impact objects and even punctures.

In one embodiment, the vehicle solar wrap device is utilized with any conventional electric vehicle as is known in the art. Typically, the electric vehicle is a conventional electric powered vehicle having an electric motor mounted therein which is connected to the vehicle drive train for propelling the vehicle. The electric motor receives electrical energy from a plurality of parallel connected batteries (or a single battery) which are mounted within the vehicle. The batteries may be recharged by connection through a conventional battery recharger to a suitable source of electrical energy, such as an electrical outlet connected to the electrical circuit within a building or residential home.

In one embodiment, the vehicle is an electric vehicle that runs off a battery pack stored on the vehicle. In another embodiment the vehicle may be hybrid-gasoline vehicle or a fuel-cell powered vehicle or any combination thereof.

In one embodiment, the vehicle solar wrap device comprises a body component that is configured in a shape of a vehicle or of a vehicle part (i.e., body panel, roof, hood, door, etc.). The body component is a thin wrap that functions like a protective automotive film. Typically, the film is applied to all painted surfaces of the vehicle or just some of the painted surfaces depending on the needs and/or wants of a user. Generally, the film is laser measured and cut according to a vehicle's specific body panel, shape, and design.

In one embodiment, the back sheet of the body component contains an adhesive layer for easy application of the body component to the vehicle. In use, the body component is applied by removing the release liner and applying the body component film to the parts of the vehicle as desired by a user. This application is performed in much the same way as a protective automotive film and window tint are applied. Further, the application of the body component can be done at the point of manufacture or after market for the desired vehicle. Thus, users can apply or have applied the body component film to any desired vehicle part or parts. In another embodiment, the body component can be prepared without an adhesive layer which can be added later or the body component can be applied via some other securing means.

In one embodiment, the body component comprises a plurality of thin, flat photovoltaic cells (or other means, such as electromagnetic energy or gamma rays) which capture solar energy to charge the vehicle's batteries. Specifically, the plurality of thin, flat photovoltaic cells are integrated into the body component film. Thus, the photovoltaic cells in the body component serve a dual purpose: reducing the reliance on traditional energy sources and providing a sustainable auxiliary power system for EVs. Further, the seamless incorporation of thin-film photovoltaic cells into the body component film provides for flexibility. Unlike conventional solar panels, these photovoltaic cells are flexible and transparent, allowing for their application on the curved surfaces of a vehicle's body without obstructing the aesthetics of the vehicle. In one embodiment, the body component of photovoltaic cells can also be applied to the windshield or windows of a vehicle without impeding a user's sight while driving, as the photovoltaic cells can be transparent.

In one embodiment, the plurality of thin, flat photovoltaic cells are operative to convert incident solar radiation into electrical energy. The photovoltaic cells are integrated into the body component film and applied to the vehicle body and are electrically connected to the batteries via terminating ends of the photovoltaic cells' bus bars being attached to wires or to the body of the vehicle itself or other suitable connecting means and are operative to supply electrical current thereto for recharging the batteries. The photovoltaic cells are identically constructed and only differ in size, so as to conform the photovoltaic cells to the size and configuration of the exterior surface of the vehicle on which they are mounted. The photovoltaic cells can also be constructed in different configurations for aesthetics or greater functionality.

Generally, the photovoltaic cells are conventional photovoltaic cells and are operative to convert solar radiation incident thereon into electrical energy. The series of photovoltaic cells are arranged in a thin layer. As is commonly known, a photovoltaic cell is formed of an amorphous semi-conductor material, such as silicon. As the interconnection of the individual cells is well known and is not germane to the present invention, details of such interconnection will not be described herein. It will be understood, however, that such individual photovoltaic cells are interconnected, so as to provide through a common output cable a constant flow of electrical energy.

In one embodiment, the plurality of photovoltaic cells may be at least partially encapsulated by one or more encapsulant layers. For example, in some embodiments, the photovoltaic cells can include an encapsulant which is an effective water barrier, and may include polychlorotrifluoroethylene (PCTFE), a fluoropolymer resin, polysiloxanes (e.g., silicone), and/or ethyl vinyl acetate (EVA). In various embodiments, one or more anti-reflection (AR) coatings may be coupled to an exterior surface of the photovoltaic cells, as well.

In one embodiment, the photovoltaic cells are electrically connected through a voltage regulator to the batteries via the terminating ends of the bus bars, which are attached to wires or to the body of the vehicle itself, which will serve as the interconnection between the charge controller and the battery (or other power storage device). The batteries, as is conventional, are electrically connected to the charge controller and an electric motor which, when energized, propels the vehicle. In this configuration, the photovoltaic cells act as a supplemental source of energy for the batteries, which extends the driving range of the vehicle and reduces the recharging time for the batteries, as well as reduces cost by not requiring or requiring less purchased energy.

Any suitable number of photovoltaic cells can be utilized to form the body component film, depending on the shape and size of the vehicle to which it is to be applied. Further, the photovoltaic cells can be any suitable shape and size, as needed.

In one embodiment, the battery is the vehicle battery that powers the vehicle, which in one embodiment may be an electric vehicle. When the photovoltaic cells are positioned on the vehicle and facing the sun, the battery within the electric vehicle can be charged by the photovoltaic cells.

Accordingly, the vehicle solar wrap device provides an increased solar radiation collection surface area which generates added amounts of electrical energy for recharging the batteries in an electric vehicle. This not only extends the driving range of the vehicle but substantially reduces the recharging time of the batteries when the batteries are connected to an alternate source of electrical energy, such as the electrical circuit in a building or a residential home.

In one embodiment, the vehicle solar wrap device can be available in numerous colors, styles, and designs to accommodate all vehicles and all user needs and preferences.

In yet another embodiment, the vehicle solar wrap device comprises a plurality of indicia.

In yet another embodiment, a method of charging an electric vehicle through a solar wrap is disclosed. The method includes the steps of providing a vehicle solar wrap device comprising a body component that is thin film for a vehicle. The method also comprises laser cutting the body component to a vehicle's specific body type. Further, the method comprises applying the body component to the vehicle via an adhesive backing on the body component. The method also comprises attaching the terminating ends of the bus bars to wire or the vehicle body itself to serve as the interconnection between the charge controller and the battery. Finally, the method comprises absorbing solar energy from the photovoltaic cells on the body component and charging the vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the vehicle solar wrap device of the present invention in accordance with the disclosed architecture;

FIG. 2 illustrates a perspective view of one embodiment of the vehicle solar wrap device of the present invention showing the body component applied to a vehicle in accordance with the disclosed architecture;

FIG. 3 illustrates a perspective view of one embodiment of the vehicle solar wrap device of the present invention showing the device in use in accordance with the disclosed architecture;

FIG. 4 illustrates a perspective view of one embodiment of the vehicle solar wrap device of the present invention showing the photovoltaic cells used to charge a vehicle's batteries in accordance with the disclosed architecture;

FIG. 5 illustrates a perspective view of one embodiment of the vehicle solar wrap device of the present invention showing the different colors and styles available in accordance with the disclosed architecture; and

FIG. 6 illustrates a flowchart showing the method of charging an electric vehicle through a solar wrap in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vehicle solar wrap device that provides users with a vehicle wrap or film designed to fit snugly on a vehicle exterior and absorbs solar energy for converting it to usable power. There is also a long felt need in the art for a vehicle solar wrap device that allows users to travel or park their vehicle and charge their vehicle without plugging it into a power system. Further, there is a long felt need in the art for a vehicle solar wrap device that utilizes a thin wrap that functions like protective film and can be applied to all painted surfaces on the vehicle. Moreover, there is a long felt need in the art for a device that maximizes the available surface area for capturing solar energy while improving or maintaining vehicle aesthetics. Further, there is a long felt need in the art for a vehicle solar wrap device that offers a way to provide continuous power to an electric vehicle regardless of sun position. Finally, there is a long felt need in the art for a vehicle solar wrap device that can be available in numerous colors, styles and designs.

The present invention, in one exemplary embodiment, is a novel vehicle solar wrap device. The vehicle solar wrap device comprises a body component that is configured in a shape of a vehicle. The body component is a thin wrap that functions like a protective automotive film. The film is applied to all painted surfaces of the vehicle. The body component captures solar energy through thin, flat photovoltaic cells to charge the vehicle's batteries. The film is laser measured and cut according to a vehicle's specific body panel, shape, and design. The terminating ends of the bus bars will be attached to wires or the body of the vehicle itself, which will serve as the interconnection between the charge controller and the battery (or other power storage device). Further, the back sheet of the body component will contain an adhesive layer for application to the vehicle. The present invention also includes a novel method of charging an electric vehicle through a solar wrap. The method includes the steps of providing a vehicle solar wrap device comprising a body component that is thin film for a vehicle. The method also comprises laser cutting the body component to a vehicle's specific body type. Further, the method comprises applying the body component to the vehicle via an adhesive backing on the body component. The method also comprises attaching the terminating ends of the bus bars to wire or the vehicle body itself to serve as the interconnection between the charge controller and the battery. Finally, the method comprises absorbing solar energy from the photovoltaic cells on the body component and charging the vehicle.

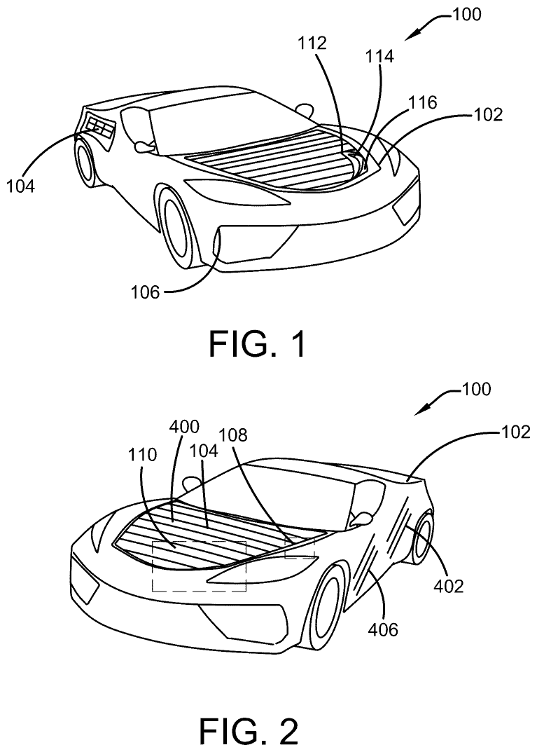

Referring initially to the drawings, FIGS. 1-2 illustrate a perspective view of one embodiment of the vehicle solar wrap device 100 of the present invention. In the present embodiment, the vehicle solar wrap device 100 is an improved vehicle solar wrap device 100 that provides a user with a film for converting solar power into energy to charge vehicles 106. Specifically, the vehicle solar wrap device 100 comprises a body component 102 with a plurality of thin, flat photovoltaic cells 104 (or other means, such as in the absorption of electromagnetic energy or gamma rays from solar radiation). The body component 102 is applied to all painted surfaces or selected surfaces of the vehicle 106. Thus, the film can be applied to all exterior surfaces reachable by sunlight. The body component 102 captures solar energy through the thin, flat photovoltaic cells 104 to charge the vehicle's batteries 108. The film 102 is laser measured and cut according to a vehicle's specific body panel, shape, and design.

Generally, the vehicle solar wrap device 100 provides users with a vehicle wrap or film designed to fit snugly on a vehicle exterior and absorbs solar energy for converting it to useable power. Thus, the device 100 converts solar power into energy to charge vehicles 106 containing batteries 108. The vehicle solar wrap device 100 maximizes the available surface area for capturing solar energy while improving or maintaining vehicle aesthetics. Accordingly, the device 100 offers a way to provide continuous power to an electric vehicle 106 regardless of sun position.

Further, the vehicle solar wrap device 100 is utilized with any conventional electric vehicle 106 as is known in the art. Typically, the electric vehicle 106 is a conventional electric powered vehicle having an electric motor 110 mounted therein which is connected to the vehicle drive train for propelling the vehicle 106. The electric motor 110 receives electrical energy from a plurality of parallel connected batteries 108 or a single battery 108 which are mounted within the vehicle 106. The batteries 108 may be recharged by connection through a conventional battery recharger to a suitable source of electrical energy, such as an electrical outlet connected to the electrical circuit within a building or residential home.

In one embodiment, the vehicle 106 is an electric vehicle that runs off a battery pack stored on the vehicle 106. In another embodiment the vehicle 106 may be hybrid-gasoline vehicle or a fuel-cell powered vehicle or any combination thereof.

Additionally, the vehicle solar wrap device 100 comprises a body component 102 that is configured in a shape of a vehicle 106 or of a vehicle part (i.e., body panel, roof, hood, door, etc.). The body component 102 is a thin wrap that functions like a protective automotive film. Typically, the film 102 is applied to all exterior surfaces of the vehicle 106 or just some of the exterior surfaces depending on the needs and/or wants of a user. Generally, the film 102 is laser measured and cut according to a vehicle's specific body panel, shape, and design.

Furthermore, the back sheet 112 of the body component 102 contains an adhesive layer 114 for easy application of the body component 102 to the vehicle 106. In use, the body component 102 is applied by removing the release liner 116 and applying the body component film 102 to the parts of the vehicle 106 as desired by a user. This application is performed in much the same way as a protective automotive film and window tint are applied. Further, the application of the body component 102 can be done at the point of manufacture or after market for the desired vehicle 106. Thus, users can apply or have applied the body component film 102 to any desired vehicle part or parts. In another embodiment, the body component can be prepared without an adhesive layer which can be added later or the body component can be applied via some other securing means.

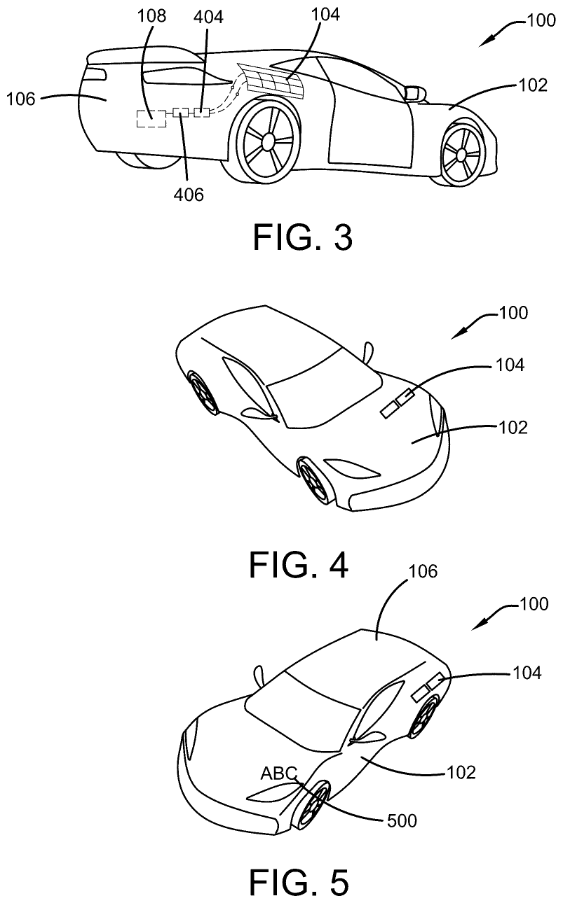

As shown in FIGS. 3-4, the body component 102 comprises a plurality of thin, flat photovoltaic cells 104 which capture solar energy to charge the vehicle's batteries 108. Specifically, the plurality of thin, flat photovoltaic cells 104 are integrated into the body component film 102. Thus, the photovoltaic cells 104 in the body component 102 serve a dual purpose: reducing the reliance on traditional energy sources and providing a sustainable auxiliary power system for EVs. Further, the seamless incorporation of thin-film photovoltaic cells 104 into the body component film 102 provides for flexibility. Unlike conventional solar panels, these photovoltaic cells 104 are flexible and transparent, allowing for their application on the curved surfaces of a vehicle's body without obstructing the aesthetics of the vehicle 106. In one embodiment, the body component 102 of photovoltaic cells 104 can also be applied to the windshield or windows of a vehicle 106 without impeding a user's sight while driving, as the photovoltaic cells 104 can be transparent.

Further, the plurality of thin, flat photovoltaic cells 104 are operative to convert incident solar radiation into electrical energy. The photovoltaic cells 104 are integrated into the body component film 102 and applied to the vehicle body 106 and are electrically connected to the batteries 108 via terminating ends 300 of the photovoltaic cells' bus bars being attached to wires or to the body of the vehicle 106 itself or other suitable connecting means as is known in the art, and are operative to supply electrical current thereto for recharging the batteries 108. The photovoltaic cells 104 are identically constructed and only differ in size, so as to conform the photovoltaic cells 104 to the size and configuration of the exterior surface of the vehicle 106 on which they are mounted.

Generally, the photovoltaic cells 104 are conventional photovoltaic cells 104 and are operative to convert solar radiation incident thereon into electrical energy. The series of photovoltaic cells 104 are arranged in a thin layer. As is commonly known, a photovoltaic cell 104 is formed of an amorphous semi-conductor material, such as silicon. As the interconnection of the individual cells is well known and is not germane to the present invention, details of such interconnection will not be described herein. It will be understood, however, that such individual photovoltaic cells 104 are interconnected, so as to provide through a common output cable a constant flow of electrical energy.

In one embodiment, the plurality of photovoltaic cells 104 may be at least partially encapsulated by one or more encapsulant layers. For example, in some embodiments, the photovoltaic cells 104 can include an encapsulant which is an effective water barrier 400, and may include polychlorotrifluoroethylene (PCTFE), a fluoropolymer resin, polysiloxanes (e.g., silicone), and/or ethyl vinyl acetate (EVA). In various embodiments, one or more anti-reflection (AR) coatings 402 may be coupled to an exterior surface of the photovoltaic cells 104, as well.

In another embodiment, the photovoltaic cells 104 are electrically connected through a voltage regulator 404 to the batteries 108 via the terminating ends 300 of the bus bars, which are attached to wires or to the body of the vehicle 106 itself, which will serve as the interconnection between the charge controller 406 and the battery 108 (or other power storage device). The batteries 108, as is conventional, are electrically connected to the charge controller 406 and an electric motor 110 which, when energized, propels the vehicle 106. In this configuration, the photovoltaic cells 104 act as a supplemental source of energy for the batteries 108, which extends the driving range of the vehicle 106 and reduces the recharging time for the batteries 108.

Further, the battery 108 is the vehicle battery that powers the vehicle 106, which in one embodiment may be an electric vehicle. When the photovoltaic cells 104 are positioned on the vehicle 106 and facing the sun, the battery 108 within the electric vehicle 106 can be charged by the photovoltaic cells 104.

As shown in FIG. 5, any suitable number of photovoltaic cells 104 can be utilized to form the body component film 102, depending on the shape and size of the vehicle 106 to which it is to be applied. Further, the photovoltaic cells 104 can be any suitable shape and size, as needed.

Accordingly, the vehicle solar wrap device 100 provides an increased solar radiation collection surface area which generates added amounts of electrical energy for recharging the batteries 108 in an electric vehicle 106. This not only extends the driving range of the vehicle 106 but substantially reduces the recharging time of the batteries 108 when the batteries 108 are connected to an alternate source of electrical energy, such as the electrical circuit in a building or a residential home.

In one embodiment, the vehicle solar wrap device 100 can be available in numerous colors, styles, and designs to accommodate all vehicles 106 and all user needs and preferences.

In yet another embodiment, the vehicle solar wrap device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be vehicle, photovoltaic cells, or brand related.

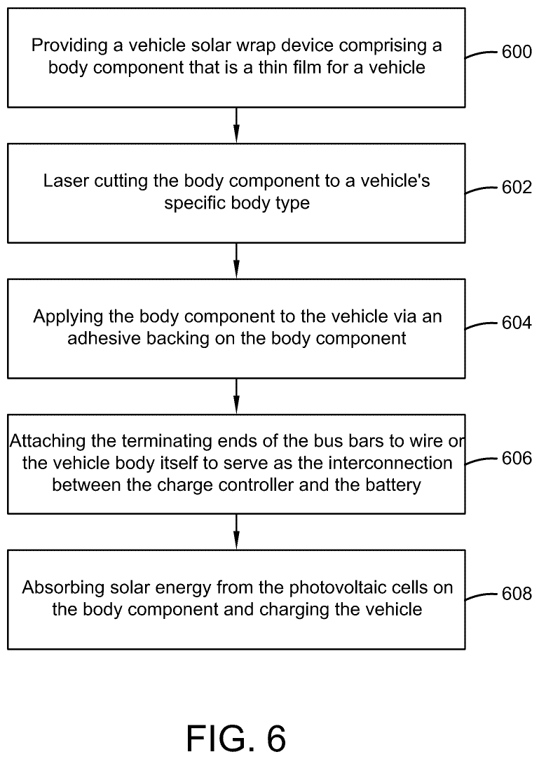

FIG. 6 illustrates a flowchart of the method of charging an electric vehicle through a solar wrap. The method includes the steps of at 600, providing a vehicle solar wrap device comprising a body component that is thin film for a vehicle. The method also comprises at 602, laser cutting the body component to a vehicle's specific body type. Further, the method comprises at 604, applying the body component to the vehicle via an adhesive backing on the body component. The method also comprises at 606, attaching the terminating ends of the bus bars to wire or the vehicle body itself to serve as the interconnection between the charge controller and the battery. Finally, the method comprises at 608, absorbing solar energy from the photovoltaic cells on the body component and charging the vehicle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “vehicle solar wrap device”, “solar wrap device”, “vehicle device”, and “device” are interchangeable and refer to the vehicle solar wrap device 100 of the present invention.

Notwithstanding the forgoing, the vehicle solar wrap device 100 of the present invention can be of any suitable size and configuration as is known in the art without affecting the overall concept of the invention, provided that it accomplishes the above stated objectives. One of ordinary skill in the art will appreciate that the vehicle solar wrap device 100 as shown in FIGS. 1-6 is for illustrative purposes only, and that many other sizes and shapes of the vehicle solar wrap device 100 are well within the scope of the present disclosure. Although the dimensions of the vehicle solar wrap device 100 are important design parameters for user convenience, the vehicle solar wrap device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle solar wrap device that provides a user with a film for converting solar power into energy to charge vehicles, the vehicle solar wrap device comprising:
a body component; and
a plurality of photovoltaic cells;
wherein the plurality of photovoltaic cells are integrated into the body component;
wherein the body component is applied to all selected surfaces of an electric vehicle; and
further wherein the plurality of photovoltaic cells capture solar energy to charge the electric vehicle's batteries.

2. The vehicle solar wrap device of claim 1, wherein the vehicle solar wrap device is utilized with any conventional electric vehicle having an electric motor mounted therein which is connected to a vehicle drive train for propelling the electric vehicle.

3. The vehicle solar wrap device of claim 2, wherein the body component is configured in a shape of the electric vehicle.

4. The vehicle solar wrap device of claim 2, wherein the body component is configured in a shape of an electric vehicle part, such as a body panel, roof, hood, or door.

5. The vehicle solar wrap device of claim 2, wherein the body component 102 is a thin wrap that functions like a protective automotive film.

6. The vehicle solar wrap device of claim 5, wherein the body component is laser measured and cut according to an electric vehicle's specific body panel, shape, and design.

7. The vehicle solar wrap device of claim 6, wherein the body component comprises an adhesive back sheet for application to the electric vehicle body.

8. The vehicle solar wrap device of claim 7, wherein the body component is applied by removing a release liner off the adhesive back sheet and applying the body component to the electric vehicle body.

9. The vehicle solar wrap device of claim 8, wherein the plurality of photovoltaic cells are flexible and transparent, allowing for their application on curved surfaces of the electric vehicle's body without obstructing aesthetics of the electric vehicle.

10. The vehicle solar wrap device of claim 9, wherein the plurality of photovoltaic cells are operative to convert incident solar radiation into electrical energy and are electrically connected to the electric vehicle's batteries via terminating ends of a bus bar being attached to wires or to the electric vehicle body.

11. The vehicle solar wrap device of claim 10, wherein the plurality of photovoltaic cells are at least partially encapsulated by a water barrier layer.

12. The vehicle solar wrap device of claim 11, wherein the plurality of photovoltaic cells are at least partially encapsulated by an anti-reflection coating.

13. The vehicle solar wrap device of claim 12, wherein the plurality of photovoltaic cells are electrically connected through a voltage regulator to the electric vehicle's batteries.

14. A vehicle solar wrap device that provides a user with a film for converting solar power into energy to charge vehicles, the vehicle solar wrap device comprising:
a body component which is a thin wrap that functions like a protective automotive film; and
a plurality of photovoltaic cells;
wherein the plurality of photovoltaic cells are integrated into the body component;
wherein the body component is applied to all selected surfaces of an electric vehicle;
wherein the body component is laser measured and cut according to an electric vehicle's specific body panel, shape, and design;
wherein the body component comprises an adhesive back sheet for application to the electric vehicle body;
wherein the plurality of photovoltaic cells capture solar energy to charge the electric vehicle's batteries; and
further wherein the plurality of photovoltaic cells are operative to convert incident solar radiation into electrical energy and are electrically connected to the electric vehicle's batteries via terminating ends of a bus bar being attached to wires or to the electric vehicle body.

15. The vehicle solar wrap device of claim 14, wherein any suitable number of photovoltaic cells can be utilized to form the body component, depending on shape and size of the electric vehicle to which it is to be applied.

16. The vehicle solar wrap device of claim 14, wherein application of the body component can be done at a point of manufacture or after market for a desired electric vehicle.

17. The vehicle solar wrap device of claim 14, wherein the plurality of photovoltaic cells are identically constructed and only differ in size, so as to conform to size and configuration of exterior surface of the electric vehicle on which they are mounted.

18. The vehicle solar wrap device of claim 14 wherein the vehicle solar wrap device is available in numerous colors, styles, and designs to accommodate all electric vehicles.

19. The vehicle solar wrap device of claim 14 further comprising a plurality of indicia.

20. A method of charging an electric vehicle through a solar wrap, the method comprising the following steps:
providing a vehicle solar wrap device comprising a body component that is thin film for a vehicle;
laser cutting the body component to a vehicle's specific body type;
applying the body component to the vehicle via an adhesive backing on the body component;
attaching the terminating ends of the bus bars to wire or the vehicle body itself to serve as the interconnection between the charge controller and the battery; and
absorbing solar energy from the photovoltaic cells on the body component and charging the vehicle.
